(19) United States
(12) Patent Application Publication
(10) Pub. No.: US 2018/0253786 A1
(43) Pub. Date: Sep. 6, 2018

(54) SYSTEMS AND METHODS FOR LOCKER RENTAL AND OPERATION

(71) Applicant: Tangible, L.L.C., Scottsdale, AZ (US)

(72) Inventors: Joshua Frisby, Tempe, AZ (US); Zachary Rolfness, Tempe, AZ (US); Kenneth Nyhus, Tempe, AZ (US)

(73) Assignee: Tangible, L.L.C., Scottsdale, AZ (US)

(21) Appl. No.: 15/449,504

(22) Filed: Mar. 3, 2017

(51) Int. Cl. G06Q 30/06; H04L 29/08; E05B 47/00; E05B 65/02

(52) U.S. Cl. CPC G06Q 30/0645; H04L 67/306; H04L 67/42; E05B 65/025; E05B 47/0001

(57) ABSTRACT

A method of operating lockers may include the step of receiving a request from a mobile device to rent a locker. The mobile device is associated with a user account. The method further includes assigning the locker to the user account associated with the mobile device, receiving a state request to lock the locker from the mobile device, and actuating an electronic lock of the locker in response to the state request. A locker system is also provided. The locker system may include a locker bay having a locker, an electronic lock coupled to the locker and configured to lock a door of the locker, and a locker computer configured to control the electronic lock. A server may be in electronic communication with the locker computer to receive a request from a mobile application and transmit instructions to the locker computer in response to the request.

### FIELD

The present disclosure relates to systems and methods for renting and controlling lockers from a computing device.

### BACKGROUND

Almost everyone has found themselves carrying personal belongings without a place to leave them. Kids at a water park lock up clothes, patrons at skating rinks lock up their shoes, moms lock up their bags at amusement parks. Coin-operated lockers are particularly common in public places where people may not carry any other means to safely store their belongings. Coin-operated lockers typically have a removable key that locks and unlocks the locker. Users can turn the key after inserting coins in the locker in most instances. The user then removes the key and carries the key with them throughout the day in lieu of the items placed in the locker. Locker users typically have to carry coins or cash to operate such lockers. Once they stow their belongings, the users then carry the key around. Users are thus inconvenienced by carrying money for the initial rental and the key for subsequent use.

Another common type of locker is the community locker that you might find at a gym. These lockers have no integrated lock. Rather, these community lockers include an interface to accept a personal lock. In order to secure their items, a user thus has to bring a personal lock to lock the locker. These lockers are often left unlocked as many users do not carry a personal lock. Valuables left in unlocked lockers can leave their owners exposed to theft and vandalism.

### SUMMARY

A method of operating lockers is provided. The method includes the step of receiving a request from a mobile device to rent a locker. The mobile device is associated with a user account. The method further includes assigning the locker to the user account associated with the mobile device, receiving a state request to lock the locker from the mobile device, and actuating an electronic lock of the locker in response to the state request.

In various embodiments, the method may also include deducting a rental fee from the user account. The rental fee may be determined based on at least one of a rental timer, a flat rate, or actuating the electronic lock. Payment data may be stored in a database in association with the user account. The locker may be associated with the user account in the database. A rental timer may start in response to at least one of assigning the locker, receiving the state request, or actuating the electronic lock. The method may also include the steps of determining a distance between the mobile device and a locker beacon, and identifying the locker based at least in part on the distance between the mobile device and the locker beacon. The locker may be identified in response to detecting an input to a mobile application running on the mobile device.

A locker system is also provided. The locker system may include a locker bay having a locker, an electronic lock coupled to the locker and configured to lock a door of the locker, and a locker computer configured to control the electronic lock. A locker beacon may be configured to broadcast a signal about the locker bay. A server may be in electronic communication with the locker computer. The server may also be configured to receive a request from a mobile application and transmit instructions to the locker computer in response to the request.

In various embodiments, a database may be accessible to the server to retrieve data associated with a user account. The server may deduct a rental fee from the user account using the data. The electronic lock comprises an electromechanical actuator and/or a solenoid. The server may determine a distance between the locker beacon and a mobile device running the mobile application. The locker may be identified based at least in part on the distance between the locker beacon and the mobile device running the mobile application.

The forgoing features and elements may be combined in various combinations without exclusivity, unless expressly indicated herein otherwise. These features and elements as well as the operation of the disclosed embodiments will become more apparent in light of the following description and accompanying drawings. The contents of this summary section are not intended to be used to limit the scope of any claim.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1 illustrates a locker system for purchasing and controlling lockers using a computing device, in accordance with various embodiments;

FIG. 2 illustrates a locker bay having a wireless communication device and a computing device to lock and unlock doors, in accordance with various embodiments;

FIG. 3 illustrates control logic for purchasing and controlling individual lockers in a locker bay, in accordance with various embodiments; and

FIG. 4 illustrates a process for renting out lockers and deducting the rental fee from a payment account, in accordance with various embodiments.

### DETAILED DESCRIPTION

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

The systems and methods disclosed herein enable users to rent and control lockers using a computing device. For example, users may place a mobile computing device in front of a locker to initiate a rental transaction for the locker. The locker bay may detect the presence of the mobile device and/or the location of the mobile device at the selected locker to identify the selected locker for rental. The mobile device may also detect the presence and/or location of the locker. The user may thus rent the locker without the need to carry a key or cash.

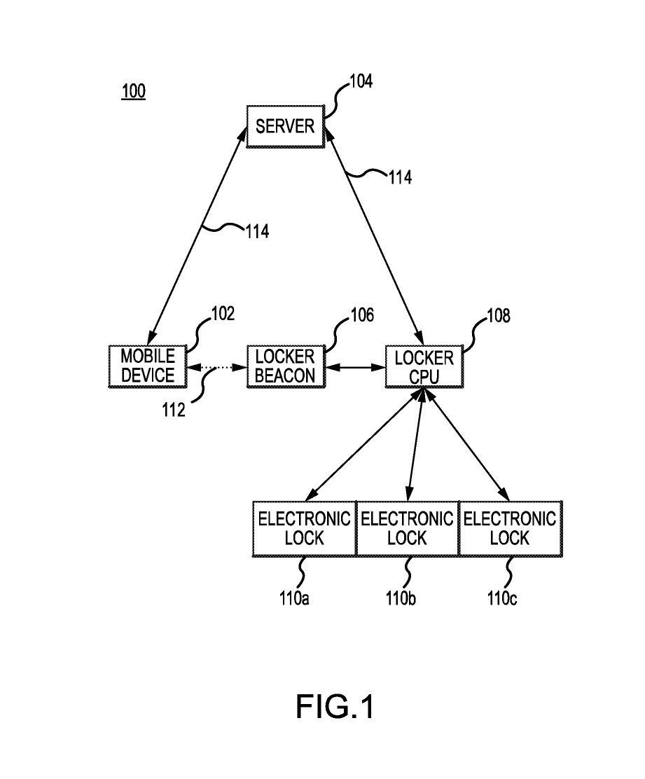

With reference to FIG. 1, locker system 100 for renting lockers is shown, in accordance with various embodiments. Locker system 100 may include a mobile device 102 with a native application or web application running on the mobile device. The application on mobile device 102 may facilitate user registration with server 104. Server 104 may be located at a different geographic location than electronic locks 110 of lockers. Mobile device 102 may include computing devices suitable for electronic communication with server 104. Mobile device 102 may thus be any suitable computing device (e.g., personal computing device/mobile communication device) which communicates via any network. For example, mobile device 102 may include laptops, notebooks, servers, hand held computers, personal digital assistants, cellular phones, smartphones, tablets, wearable computing devices such as smart watches or smart glasses, or any suitable device capable of receiving data over network 114. Server 104 may comprise a computing device for managing user accounts and locker bays such as, for example, a rack mounted server, a personal computer, a laptop, or any other computing device capable of managing user accounts and controlling locker bays.

Mobile device 102 and/or an application running on mobile device 102 may be in electronic communication with server 104 over network 114 to register and/or manage the status of a user account and/or locker. Registration of a user account may include personal information and/or payment information being sent to server 104. The account may be associated with mobile device 102 by, for example, logging in to the mobile account in the native application or web application running on mobile device 102. Registered users may have accounts including an account number or other identifier associated with the account and used for account identification. The application running on mobile device 102 may also include an interface to rent, return, lock, unlock, or otherwise interact with a locker.

Network 114 may use any available networking technology. For example, a network may include any cloud, cloud computing system or electronic communications system or method which incorporates hardware and/or software components. Communication among the parties may be accomplished through any suitable communication channels, such as, for example, a telephone network, an extranet, an intranet, Internet, point of interaction device, online communications, satellite communications, off-line communications, wireless communications, transponder communications, local area network (LAN), wide area network (WAN), virtual private network (VPN), networked or linked devices and/or any suitable communication device. Moreover, although the system is frequently described herein as being implemented with TCP/IP communications protocols, the system may also be implemented using IPX, APPLE®talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers.

Communications over networks described herein may thus be encrypted. Encryption may be performed by way of any of the techniques now available in the art or which may become available. Exemplary cryptographic techniques include Twofish, RSA, El Gamal, Schorr signature, DSA, PGP, PKI, GPG (GnuPG), and symmetric and asymmetric cryptosystems.

Server 104 and locker computer 108 may also be in communication over a network 114 such as, for example, the Internet. Locker computer 108 may be a computing device in electronic communication with locker beacon 106 and electronic locks 110. Locker beacon 106 may broadcast a signal detectable by mobile device 102. Locker computer 108 may receive data from locker beacon 106 and/or mobile device 102 in response to mobile device 102 being in a predetermined location relative to locker beacon 106. Locker computer may control an electronic lock 110a in response to the mobile device 102 being placed near the locker door corresponding to electronic lock 110a.

Locker beacon 106 may be a Bluetooth® enabled device (e.g., a wireless beacon) communicating using a low power or low energy Bluetooth® communication standard such as the standard commonly referred to as Bluetooth® low energy or BLE. Locker beacon 106 may thus be a BLE beacon or similar device. Thus, although phrases similar to “BLE beacon” are used herein with particular respect to a Bluetooth® low-energy-consuming device, a locker beacon 106 may comprise any device capable of wireless electronic communication over wireless communication channel 112 with mobile device 102 and/or determining a location of mobile device 102. In that regard, locker beacon 106 may broadcast a signal detectable by mobile device 102 over the wireless communication channel.

As those skilled in the art will appreciate, mobile device 102 may include an operating system (e.g., Windows NT, 95/98/2000/CE/Mobile/Win7/Win8/Win10, OS2, UNIX, Linux, Solaris, iOS, Android, etc.) as well as various conventional support software and drivers typically associated with computers. A user device may implement security protocols such as Secure Sockets Layer (SSL) and Transport Layer Security (TLS) for communication over a network. Any device used in locker system 100 may also implement one or more application layer protocols, including, for example, HTTP, HTTPS, FTP, XMPP, and/or SFTP.

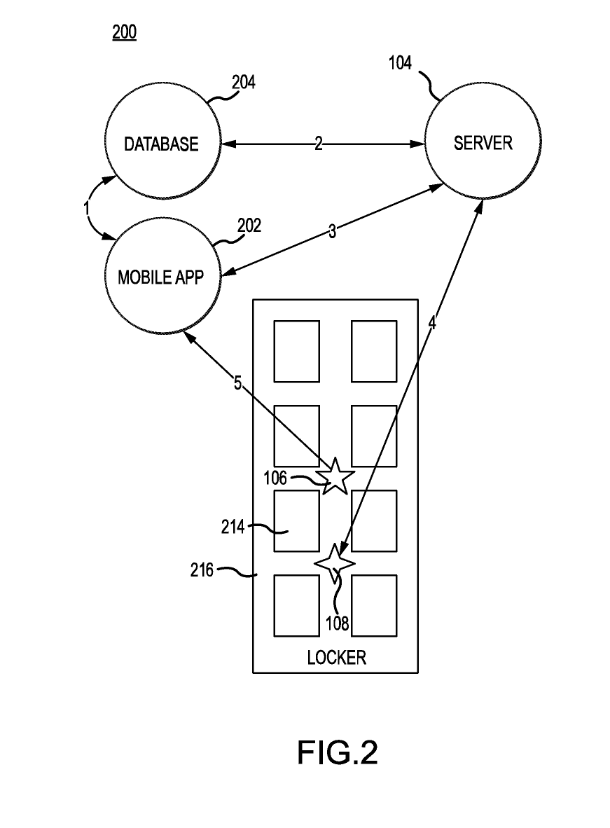

Referring now to FIG. 2, an example of a locker system 200 is shown, in accordance with various embodiments. Locker system 200 includes server 104 in communication with mobile application 202 running on mobile device 102. Mobile application 202 may be a web application or dedicated application associated with and/or running on mobile device 102. A web application may comprise a variety of browsing software or browser applications such as, for example, Microsoft Internet Explorer, Mozilla Firefox, Google Chrome, Apple Safari, a native application, or any other suitable software packages available for communicating over a network 114 and/or other communication channels. Server 104 may also provide web services by running applications such as, for example, Apache web server software or the like to interact with mobile application 202. Moreover, in various exemplary embodiments it will be appreciated that references to a single server herein may be understood as references to a plurality of servers, cloud-based systems, virtual servers, and/or the like, for example in order to provide scalability and flexibility to a system.

Mobile application 202 running on mobile device 102. may also be implemented as one or more dedicated applications. Dedicated applications may be deployed in the context of a mobile operating system, including Windows mobile, Android, or iOS, for example. The dedicated application may be configured to leverage the resources of the larger operating system and associated hardware via a set of predetermined rules which govern the operations of various operating systems and hardware resources. For example, where a dedicated application desires to communicate with a device or network other than the mobile device or mobile operating system, the dedicated application may leverage the communication protocol of the operating system and associated device hardware under the predetermined rules of the mobile operating system. Moreover, where the dedicated application desires an input from a user, the dedicated application may be configured to request a response from the operating system which monitors various hardware components and then communicates a detected input from the hardware to the dedicated application.

Mobile application 202 may register users with a database 204. Database 204 may be running on server 104, locker computer 108, or another computing device. The database may be, for example, a relational database with fields that are searchable using SQL statements to retrieve user data, billing data, and/or locker data. The database may also be a document-based database, a non-relational database, a flat file, a big data storage system, or any other suitable data storage system. The mobile application 202 may guide a user through an account registration process to initialize the user account with data used for payment and contacting the user. Mobile application 202 send new account creation data to the database in response to the database not having an account created for a user.

The mobile application 202 may contact the database and authenticate a user (e.g., using a user name and password or biometric identifier) in order to log a user into an account on mobile application 202. Mobile application 202 may give access privileges to the mobile app based on the user's authority level. Essentially, the mobile app sends a request for data from the database and the database sends the necessary data back if access to the data is granted.

The server may also access to the database to process payment information. The server may store the state changes (e.g., rented/unrented, locked/unlocked) of the locker along with time stamps to track the usage history of the locker. In general, the server may maintain the integrity of the security provided by the lockers and database. Communication between mobile application 202 and database 204 may also be carried out with the server 104 functioning as an intermediary.

Mobile application 202 may transmit a rental request and/or payment request to server 104 to process payment data. Server 104 may process the request and return to the mobile application 202 an indicator whether the payment was successful. The mobile device may be given control rights to the locker in response to a successful payment. In various embodiments, payments may also be completed after the locker rental period is completed. Mobile application 202 may relay locker rental choice information to server 104. Server 104 may forward the information to the locker computer 108 located at the locker. This process may tend to prevent rental duplication.

The locker computer 108 may transmit the status of the locks and/or lockers to the server. Status messages may inform server 104 and/or mobile device 102 as to the status of the various lockers 214 included in locker bay 216. The status messages may include indicators as to whether a locker 214 is opened, closed, locked, unlocked, rented, available, etc. Locker computer 108 may also transmit an indication as to whether the lock state successfully changed (e.g., from locked to unlocked) or whether an error was encountered.

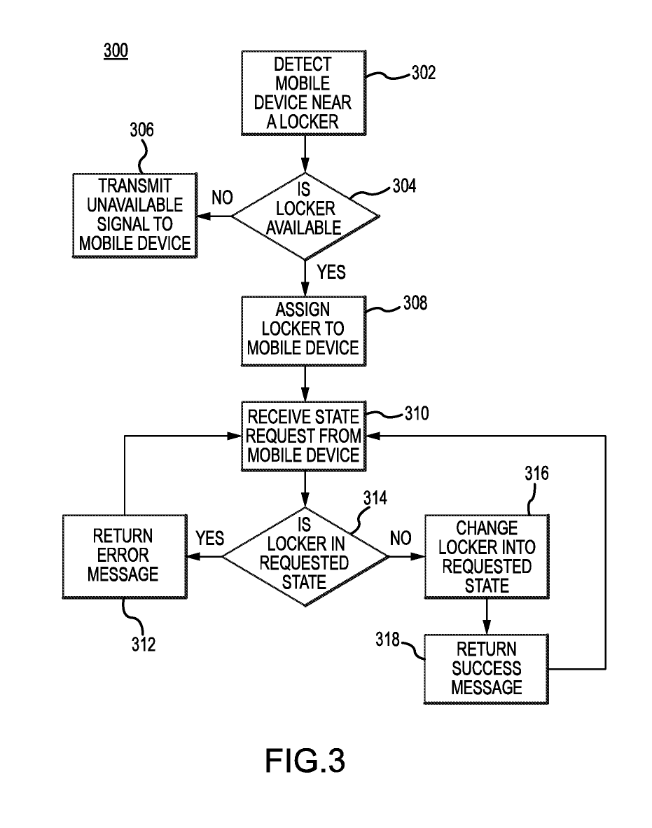

With reference to FIG. 3, a process for renting a locker 214 using locker system 200 is shown according to various embodiments. Locker system 200 includes schematic depictions of software elements that may run on the devices depicted in locker system 100, for example. Locker system 200 may detect mobile device 102 near a locker 214 (Block 302) in response to mobile device 102 detecting a wireless signal. The locker system may detect the mobile device 102 near a locker 214 using locker beacon 106. Locker beacon 106 may transmit a signal identifiable by mobile device 102 and/or mobile application 202. The signal may be analyzed to determine a distance of the mobile device 102 from a locker 214. The distance of mobile device 102 from one or more locker beacons 106 may be used to determine which locker 214 the mobile device is in front of. In various embodiments, the locker beacon 106 may also notify mobile device 102 that a locker bay is nearby. Mobile application 202 may offer a selection interface in which a user may select a vacant locker for rental. Server 104, for example, may provide the list of vacant lockers to mobile device 102. Mobile device 102 may thus identify a desired locker for rent based on the position of mobile device 102 and/or a selection of a user.

Locker system 200 may determine whether the locker 214 is available (Block 304). The locker system 200 may determine whether locker is available by polling locker computer 108 for a status report on the identified locker. The locker system 200 may also determine whether locker 214 is available by keeping an updated list of statuses for each rentable locker. In response to the locker being unavailable, locker system 300 may transmit an error signal or an unavailable signal to mobile application 202 running on mobile device 102 (Block 306). Mobile application 202 may handle the error by displaying an error message, prompting the user to select another locker, suggesting an available locker for selection, or otherwise informing the user that the selection was unavailable.

Locker system 200 may assign the locker to mobile application 202 running on mobile device 102 (Block 308) in response to the selected locker being available. Locker system 200 may assign the locker by associating the selected locker 214 with the user account logged into mobile application 202 that requested the locker. The association may be made in a database table, for example, by populating a record with a locker ID associated with the selected locker and a user ID associated with mobile application 202 running on mobile device 102. In that regard, a user may log into a user account an application running on a different computing device and access the same locker based on the association. Users may thus control, rent, return, and otherwise interact with locker system 200 even if the initially used mobile device 102 runs out of batteries, is lost, or is stolen.

Locker system 200 may receive a state request from mobile device 102 (Block 310). The state request may be a request to change the state of the locker. For example, the user may request the locker change state to rented, available, locked, unlocked, open, closed, or other states associated with the selected locker. The state request may be transmitted from mobile device 102 to server 104 or locker computer 108, for example. Locker system 200 may then determine whether the locker 214 is in the requested state (Block 314). Locker system 200 may determine the state of locker 214 by polling locker computer 108 and/or maintaining a list of current locker states. In response to the locker being in the requested state, locker system 200 may return an error message (Block 312) indicating the state has not changed and/or the locker is already in the requested state. Locker system 200 may continue to listen for state requests from mobile application 202 running on mobile device 102.

Locker system 200 may change the state of locker 214 into the requested state (Block 316). For example, locker system 200 may change the locker state by operating locker computer 108 to command an electronic lock 110a (e.g., a solenoid or electromagnetic actuator) to switch into a locker or unlocked position. Locker system 200 may return a success message (Block 318) in response to successfully changing the selected locker into the requested state. Locker system 200 may continue to listen for additional state requests from mobile device 102.

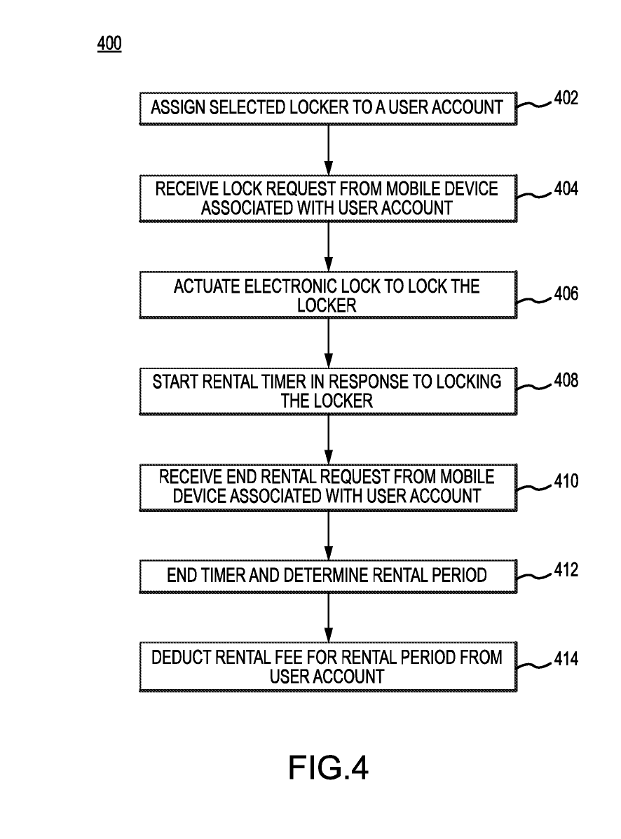

With reference to FIG. 4, an exemplary process 400 for renting lockers using locker system 200 is shown, in accordance with various embodiments. Locker system 200 may assign a selected locker to a user account (Block 402). Locker system 200 may receive a lock request from mobile device 102 associated with the user account (Block 404). Locker system 200 may actuate an electronic lock into a locked position to lock the locker (Block 406). Locker system 200 may start a rental timer in response to locking the locker (Block 408). Although locking the locker is used as an exemplary trigger for a timer in process 400, other triggers may also be used for a timer. For example, the timer may start in response to assigning the locker to the user account.

In various embodiments, locker system 200 may receive an end rental request from mobile device 102 associated with the user account (Block 410). Mobile device 102 may transmit the end rental request in response to a user pressing an unlock and/or finish rental button on mobile application 202. Locker system 200 may end the timer and determine the rental period (Block 412). The rental period may be determined as the period during which the locker has been rented (i.e., the duration the timer ran). The rental fee may be computed based on the rental timer multiplied by the rental rate. In various embodiments, the rental fee may also be determined based on a flat rate, on a per-lock basis, a per-unlock basis, or other suitable rental fee structures.

Locker system 200 may deduct the rental fee for rental period from user account (Block 414). The rental fee may be deducted from a payment account registered with the user account (e.g., a bank account or credit account). The payment may be deducted using a credit card, a debit card, an ACH transfer, or other suitable methods of fund transfer. The rental fee may also be deducted using third party payment services.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “satisfy,” “meet,” “match,” “associated with,” “identified with” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

Terms and phrases similar to “associate” and/or “associating” may include tagging, flagging, correlating, using a look-up table or any other method or system for indicating or creating a relationship between elements, such as, for example, (i) a parking spot and (ii) a user owning the parking spot. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via a text-based communication channel.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate; a user computer may include an operating system as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross-over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, wireless IEEE 802.11 wireless chip, etc. Software and data transferred via communications interface are in the form of signals which may be electronic, electromagnetic, and optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in a hard disk drive, These computer program products provide software to a computer system.

Computer programs also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

As used herein, “transmit” may include sending electronic data from one system component to another over a network connection. Additionally, as used herein, “data” may include encompassing information such as commands, queries, files, data for storage, and the like in digital or any other form.

Any databases discussed herein may include relational, hierarchical, graphical, or object-oriented structure and/or any other database configurations. Common database products that may be used to implement the databases include DB2 by IBM® (Armonk, N.Y.), various database products available from ORACLE® Corporation (Redwood Shores, Calif.), MICROSOFT® Access® or MICROSOFT® SQL Server® by MICROSOFT® Corporation (Redmond, Wash.), MySQL, by MySQL AB (Uppsala, Sweden), RethinkDB, or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 882.4 and 8825; and/or other proprietary techniques that may include fractal compression methods, image compression methods, etc.

Any of the communications, inputs, storage, databases or displays discussed herein may be facilitated through a website having web pages. The term “web page” as it is used. herein is not meant to limit the type of documents and applications that might be used to interact with the user. For example, a typical website might include, in addition to standard HTML documents, various forms, JAVA® APPLE®ts, JAVASCRIPT, active server pages (ASP), common gateway interface scripts (CGI), extensible markup language (XML), dynamic HTML, cascading style sheets (CSS), AJAX (Asynchronous JAVASCRIPT And XML), helper applications, plug-ins, and the like. A server may include a web service that receives a request from a web server, the request including a URL and an IP address (for example, an IPv4 address of the form 123.56.123.234, an IPv6 address of the form 12.134.156.229.12.123, etc.). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT, VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “JAVA® Cryptography” by Jonathan Knudson, published by O'Reilly & Associates (1998); (3) “Cryptography & Network Security: Principles & Practice” by William Stallings, published by Prentice Hall; all of which are hereby incorporated by reference.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, and C, B and C, or A and B and C.

Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A locker rental system, comprising:
a locker bay having a locker;
an electronic lock coupled to the locker and configured to lock a door of the locker;
a locker computer configured to control the electronic lock;
a locker beacon configured to broadcast a signal about the locker bay; and
a server in electronic communication with the locker computer, wherein the server is configured to receive a request from a mobile application and transmit instructions to the locker computer in response to the request.

2. The locker system of claim 1, further comprising a database accessible to the server to retrieve data associated with a user account.

3. The locker system of claim 2, wherein the server is configured to deduct a rental fee from the user account using the data.

4. The locker system of claim 1, wherein the electronic lock comprises at least one of an electromechanical actuator or a solenoid.

5. The locker system of claim 1, wherein the server is configured to determine a distance between the locker beacon and a mobile device running the mobile application.

6. The locker system of claim 5, wherein the server is configured to identify the locker based at least in part on the distance between the locker beacon and the mobile device running the mobile application.

7. A method comprising:
receiving a request from a mobile device to rent a locker, wherein the mobile device is associated with a user account and payment data associated with the user account;
assigning the locker to the user account associated with the mobile device;
receiving a state request to lock the locker from the mobile device;
actuating an electronic lock of the locker in response to the state request; and
charging the user account a rental fee for the locker using the payment data associated with the user account.

8. The method of claim 7, further comprising deducting the rental fee from a balance associated with the user account.

9. The method of claim 8, further comprising determining the rental fee based on at least one of a rental timer, a flat rate, or actuating the electronic lock.

10. The method of claim 7, further comprising storing payment data in a database in association with the user account.

11. The method of claim 10, further comprising associating the locker with the user account in the database.

12. The method of claim 7, further comprising starting a rental timer in response to at least one of assigning the locker, receiving the state request, or actuating the electronic lock.

13. The method of claim 7, further comprising:
determining a distance between the mobile device and a locker beacon; and
identifying the locker based at least in part on the distance between the mobile device and the locker beacon.

14. The method of claim 7, further comprising identifying the locker in response to detecting an input to a mobile application running on the mobile device.

15. A locker system, comprising:
a locker bay having a locker with a locked state and an unlocked state;
an electronic lock coupled to the locker, wherein the locker configured to switch between the locked state and the unlocked state in response to actuation of the electronic lock;
a beacon located near the locker bay and configured to transmit a wireless signal to a mobile device; and
a locker computer configured to actuate the electronic lock in response to a request from the mobile device.

16. The locker system of claim 15, further comprising a server in electronic communication with the locker computer and the mobile device.

17. The locker system of claim 16, further comprising a database accessible to the server to retrieve data associated with a user account logged into the mobile device.

18. The locker system of claim 17, wherein the server is configured to deduct a rental fee from the user account using the data in response to the locker being rented.

19. The locker system of claim 16, further comprising a mobile application operable on the mobile device and configured to communicate with the server to rent the locker.

20. The locker system of claim 15, wherein the electronic lock comprises at least one of an electromechanical actuator or a solenoid.
